(19) United States
(12) Patent Application Publication
(10) Pub. No.: US 2024/0340469 A1
(43) Pub. Date: Oct. 10, 2024

(54) BUNDLED MEDIA FILES

(71) Applicant: Meta Platforms, Inc., Menlo Park, CA (US)

(72) Inventors: Chirag Ramanlal Jain, Jersey City, NJ (US); Zefei Xuan, Foster City, CA (US)

(21) Appl. No.: 18/628,155

(22) Filed: Apr. 5, 2024

Related U.S. Application Data
(60) Provisional application No. 63/494,435, filed on Apr. 5, 2023.

(51) Int. Cl. H04N 21/231; G06Q 50/00

(52) U.S. Cl. CPC H04N 21/23109; G06Q 50/01

(57) ABSTRACT

Various aspects of the subject technology relate to systems, methods, and machine-readable media for bundling data into media files. The disclosed method comprises receiving a player video file, wherein the player video file is generated on a social media platform. The method includes identifying a storage section of the player video file configured to store an editable video file. The method includes generating the editable video file comprising metadata that includes a plurality of parameters associated with the player video file. A parameter of the plurality of parameters identifies an editable element of the player video file. The method includes generating a bundled video file by appending the editable video file in the storage section of the player video file. The method comprises exporting the bundled video file to storage located external to the social media platform.

### CROSS REFERENCE TO RELATED APPLICATIONS

This present application claims the benefit of priority under 35 U.S.C. § 119(e) to U.S. Provisional Application No. 63/494,435, filed Apr. 5, 2023, the disclosure of which is hereby incorporated by reference in its entirety for all purposes.

### TECHNICAL FIELD

The present disclosure generally relates to grouping data files. More particularly, the present disclosure relates to grouping a plurality of media types for accessible sharing, editing and storage

### BACKGROUND

Media files can be stored in multiple formats. The plurality of formats reduces the ease of accessibility for the respective files. In addition, storage capabilities are directly impacted by the size of the media files and variance in formatting for the media files. When using multimedia files, editing the files may require the integration of text, altering of time length, adjustment of visual effects, and addition of music, just to name a few. Certain time constraints may enter into the editing process, preventing an edit of a multimedia in a single instance. The editing process can become additionally problematic when the multimedia file is created in a social media platform instead of a conventional video editing application or platform.

### BRIEF SUMMARY

The subject disclosure provides for systems and methods for bundling data into video files generated on a video platform or social media platform. The disclosed method comprises receiving a player video file, wherein the player video file is generated on a social media platform. The method includes identifying a storage section of the player video file configured to store an editable video file. The method includes generating the editable video file comprising metadata that includes a plurality of parameters associated with the player video file. A parameter of the plurality of parameters identifies an editable element of the player video file. The method includes generating a bundled video file by appending the editable video file in the storage section of the player video file. The method comprises exporting the bundled video file to storage located external to the social media platform. The method can include retrieving the bundling video file and determining the validity of a parameter. The method can include authenticating access to the bundled video file based on the user attempting to access the bundled video file.

According to one embodiment of the present disclosure, a system can be configured to bundle data into a media file. The system may include one or more hardware processors configured by machine-readable instructions. The processor(s) may be configured to receive a player video file, wherein the player video file is generated on a social media platform. The processor(s) may be configured to identify a storage section of the player video file configured to store an editable video file. The processor(s) may be configured to generate the editable video file comprising metadata that includes a plurality of parameters associated with the player video file. A parameter of the plurality of parameters identifies an editable element of the player video file. The processor(s) may be configured to generate a bundled video file by appending the editable video file in the storage section of the player video file. The processor(s) may be configured to export the bundled video file to storage located external to the social media platform.

According to one embodiment of the present disclosure, a non-transitory computer-readable storage medium is provided including instructions (e.g., stored sequences of instructions) that, when executed by a processor, perform a method to bundle data into media files. The method includes receiving a player video file, wherein the player video file is generated on a social media platform. The method includes identifying a storage section of the player video file configured to store an editable video file. The method includes generating the editable video file comprising metadata that includes a plurality of parameters associated with the player video file. A parameter of the plurality of parameters identifies an editable element of the player video file. The method includes generating a bundled video file by appending the editable video file in the storage section of the player video file. The method comprises exporting the bundled video file to storage located external to the social media platform. The method can include retrieving the bundled video file and determining the validity of a parameter. The method can include authenticating access to the bundled video file based on the user attempting to access the bundled video file.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a device operating environment with which aspects of the subject technology can be implemented.

FIG. 2 is a block diagram illustrating an example computer system (e.g., representing both client and server) with which aspects of the subject technology can be implemented.

FIG. 3 is an example flow diagram for navigation through a shared artificial reality environment, according to certain aspects of the present disclosure.

FIG. 4 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinary skilled in the art, that the embodiments of the present disclosure may be practiced without some of these specific details. In other instances, well-known structures and techniques have not been shown in detail so as not to obscure the disclosure.

The disclosure provides a method to bundle a playable media file and editable draft file(s) into one file, which can then be used for consumption, creation, sharing, and backup. In particular, various files can be augmented to expand the capabilities for subsequent use. For example, the system can pack the burned-in video file and draft files (metadata file, video segment files, music track file, cover photo file) into one MP4 file, which can then be easily backed up or shared. The MP4 can be played by regular video player apps, and would appear as a normal, burned-in video. The bundled file can also be opened by a creation tool (e.g., INSTAGRAM® (IG) Camera). When the MP4 file is opened, the MP4 can appear as a draft file that contains all editable pieces—video segments and stickers. Since the video can be played by regular video player apps, the bundled format provides for additional functionality to identify or find editable video parameters, once the user tries to open it from both the consumption app (video player) and creation app (Instagram Camera). As an additional feature, backing up or sharing provides additional functionality because a single file can be used instead of managing multiple files. In yet a further aspect, generating a bundled file can be adapted to multiple media types including MP4s, PNGs and the like.

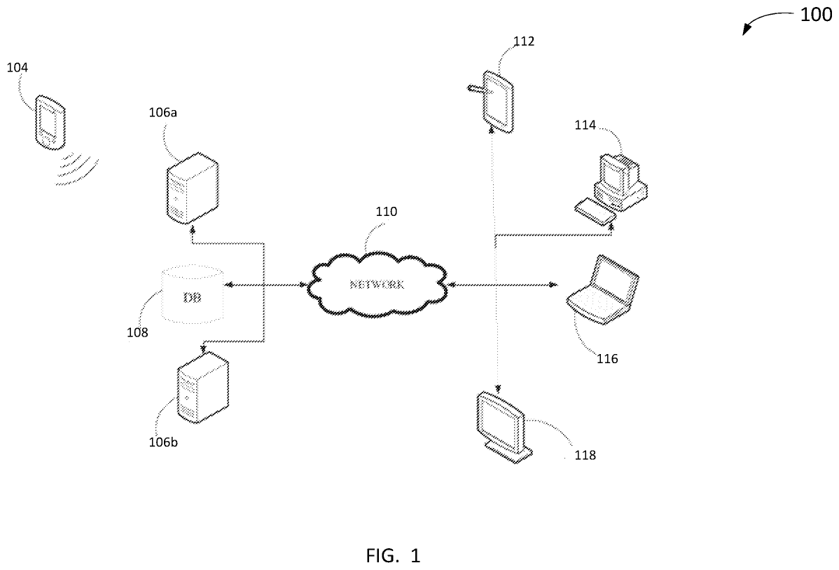

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network.

Content items transmitting via the environment 100 can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea. The social networking system can enable a user to enter and display information related to the users' interests, age/date of birth, location (e.g., longitude/latitude, country, region, city, etc.), education information, life stage, relationship status, name, a model of devices typically used, languages identified as ones the user is familiar with, occupation, contact information, or other demographic or biographical information in the users' profile. Any such information can be represented, in various implementations, by a node or edge between nodes in the social graph.

The social networking system can enable a user to upload or create pictures, videos, documents, songs, or other content items, and can enable a user to create and schedule events. Content items can be represented, in various implementations, by a node or edge between nodes in the social graph. The social networking system can enable a user to perform uploads or create content items, interact with content items or other users, express an interest or opinion, or perform other actions. The social networking system can provide various means to interact with non-user objects within the social networking system. Actions can be represented, in various implementations, by a node or edge between nodes in the social graph. For example, a user can form or join groups, or become a fan of a page or entity within the social networking system. In addition, the user can create, download, view, upload, link to, tag, edit, or play a social networking system object. The user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, the user can use location detection functionality (such as a GPS receiver on a mobile device) to “check in” to a particular location, and an edge can connect the user's node with the location's node in the social graph.

The social networking system can provide a variety of communication channels to users. For example, the social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their avatar or true-to-life representation) with objects or other avatars in a virtual environment (e.g., in an artificial reality working environment, etc.). In some embodiments, a user can post a status message to the user's profile indicating a current event, state of mind, thought, feeling, activity, or any other present-time relevant communication. The social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment where users can communicate and interact via avatars or other digital representations of themselves. Further, the first user can comment on the profile page of a second user or can comment on objects associated with the second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users, and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

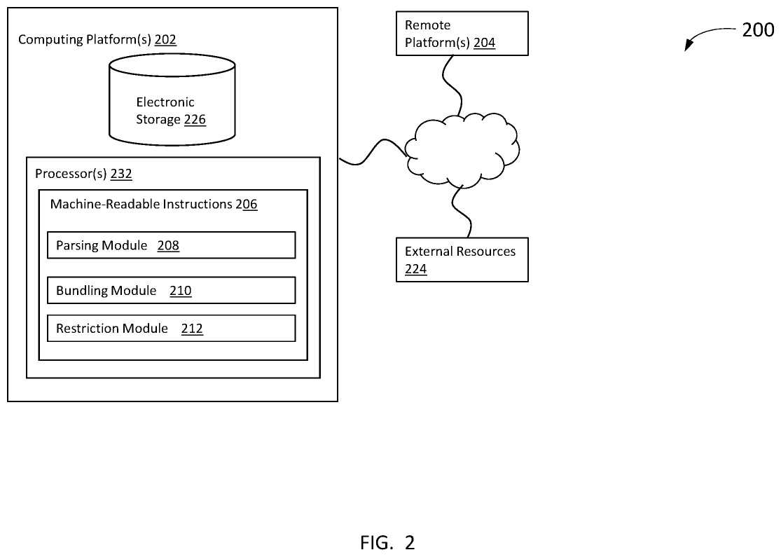

FIG. 2 is a block diagram illustrating an example computer system 200 (e.g., representing both client and server) with which aspects of the subject technology can be implemented. In some implementations, the system 200 may include one or more computing platforms 202. The one or more computing platforms 202 can be used to bundle data. The computing platform(s) 202 can also correspond to a server component of a communication platform, which can be similar to or the same as the server computing devices 106a-106b of FIG. 1 and include the processor 110 of FIG. 1. The computing platform(s) 202 can be configured to store, receive, determine, and/or analyze user preferences (e.g., communication preferences) and/or user information to determine encrypted content and non-encrypted content in the communication environment. Moreover, the one or more computing platforms 202 may host/store encrypted content that is received or uploaded as a content post for the social networking system.

The computing platform(s) 202 may be configured to communicate with one or more remote platforms 204 according to a client/server architecture, a peer-to-peer architecture, and/or other architectures. The remote platform(s) 204 may be configured to communicate with other remote platforms via computing platform(s) 202 and/or according to a client/server architecture, a peer-to-peer architecture, and/or other architectures.

The computing platform(s) 202 may be configured by machine-readable instructions 206. The machine-readable instructions 206 may be executed by the computing platform(s) to implement one or more instruction modules. The instruction modules may include computer program modules. The instruction modules being implemented may include one or more of parsing module 208, bundling module 210, restriction module 212, and/or other instruction modules.

The computing platform 202 can include a parsing module 208. The parsing module can be configured to separate the video file into functional components such as the video components, audio components and a storage section configured to store metadata. The parsing module 208 can be used to define the formatting structure of a player video file and editable video file. The player video file can comprise a video file that plays the video in a regular video player app or creation platform (e.g., social media platform). The player video file can be further configured that it does not comprise any editable components. In a further aspect, the parsing module can generate an editable video file that is configured to store the metadata and editable parameters of the player video file. The parameters are editable components of the player video file such as synchronization structure between the video components and the audio components, music track files, and image data. In a further aspect, the parsing module 208 can assign unique identifiers to the parameters in the editable datafile.

The computing platform 202 can include a bundling module 210. The bundling module 210 can be configured to append metadata including the associated parameters to the player video file. The bundled file can be subsequently edited using the added parameter data in the metadata file. The parameter data can comprise formatting and configuration data to support functionalities in video playing/editing platforms or social media platforms including: importing video footage, cutting and trimming clips, merging multiple clips, adding transitions and effects, adjusting colors and saturation, applying filters, adding text and captions, and exporting the final edited video. The unique identifiers associated with parameters can be used to reduce the size of the metadata bundled (e.g., appended) to the player video file in the platform. The identifiers can also be linked to various databases associated with the platform. These databases can comprise video configuration databases that store the relationship between the unique identifier and video configuration parameters such as size, color, aspect ratio, inlay text and the like.

The bundling module 210 can also be configured to generate metadata based on a timing threshold. For example, to save data on the respective file, the bundling module 210 may start generating metadata after a predetermined threshold has elapsed. Further, the bundling module 210 may require a minimum length of the video file prior to initiating the generation of metadata. During the bundling process, over-expansion of the video file size can be reduced by implementing a file structure that attaches identifiers to portions of the file for subsequent retrieval.

The computing platform 202 can further include a restriction module 212. In a further aspect, the restriction module can be configured to define permission rights to the parameters of the video file. The permission rights can define whether a user has permission to access and/or edit the file. Further, the restriction module can be configured to identify the parameters of the video and can be individually or collectively restricted from editing. The restriction module 212 can place an authentication requirement on the identified parameters such that a user cannot alter or edit the player video file. The authentication requirement can comprise a matched password, a permission level status (e.g., administrator) or the like. In addition to placing restrictions on the parameters, the restriction module 212 can also be configured to identify if external restrictions are placed on a parameter and enforce the restriction. For example, if the user has added a piece of background music to a video which requires a license for use, the restriction module 212 can evaluate if the license associated with the background music is still valid when the video is reopened. The restriction module can make the determination of validity for a parameter in the meta data. In determining validity, the restriction module 212 can evaluate the identifier provided to the parameter and cross-reference the identifier (e.g., license number of background music) associated with a social media platform database comprising standing valid music licenses. In the event of an expired license, the user can be notified of the restriction and the platform's inability to maintain use of the initially saved background music. The notification can be in the form of an SMS message or a pop-up display on the user interface of the platform, or the like.

In some implementations, the computing platform(s) 202, the remote platform(s) 204, and/or the external resources 224 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform(s) 202, the remote platform(s) 204, and/or the external resources 224 may be operatively linked via some other communication media.

A given remote platform 204 may include client computing devices, such as mobile device 104, tablet 112, personal computer 114, laptop 116, and desktop 118, which may each include one or more processors configured to execute computer program modules. The computer program modules may be configured to enable an expert or user associated with the given remote platform 204 to interface with the system 200 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms. The external resources 224 may include sources of information outside of the system 200, external entities participating with the system 200, and/or other resources. In a further aspect, the external resources can be databases used to store data correlated to the appended unique identifiers.

The computing platform(s) 202 may include the electronic storage 226, a processor such as the processors 232, and/or other components. The computing platform(s) 202 may include communication lines, or ports to enable the exchange of information with a network and/or other computing platforms. Illustration of the computing platform(s) 202 in FIG. 2 is not intended to be limiting. The computing platform(s) 202 may include a plurality of hardware, software, and/or firmware components operating together to provide the functionality attributed herein to the computing platform(s) 202. For example, the computing platform(s) 202 may be implemented by a cloud of computing platforms operating together as the computing platform(s) 202.

The electronic storage 226 may comprise non-transitory storage media that electronically stores information. The electronic storage media of the electronic storage 226 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). The electronic storage 226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 226 may include one or more virtual storage resources (e.g., cloud storage, a virtual private network, and/or other virtual storage resources). The electronic storage 226 may store software algorithms, information determined by the processor(s) 232, information received from computing platform(s) 202, information received from the remote platform(s) 204, and/or other information that enables the computing platform(s) 202 to function as described herein.

The processor(s) 232 may be configured to provide information processing capabilities in the computing platform(s) 202. As such, the processor(s) 232 may include one or more of a digital processor, an analog processor, a digital circuit designed to process information, an analog circuit designed to process information, a state machine, and/or other mechanisms for electronically processing information. Although the processor(s) 232 is shown in FIG. 1 as a single entity, this is for illustrative purposes only. In some implementations, the processor(s) 232 may include a plurality of processing units. These processing units may be physically located within the same device, or the processor(s) 232 may represent processing functionality of a plurality of devices operating in coordination. The processor(s) 232 may be configured to execute modules 208, 210, 212, and/or other modules. The processor(s) 232 may be configured to execute modules 208, 210, 212, and/or other modules by software; hardware; firmware; some combination of software, hardware, and/or firmware; and/or other mechanisms for configuring processing capabilities on the processor(s) 232. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although the modules 208, 210, and/or 212 are illustrated in FIG. 2 as being implemented within a single processing unit, in implementations in which the processor(s) 232 includes multiple processing units, one or more of the modules 208, 210, and/or 212 may be implemented remotely from the other modules. The description of the functionality provided by the different modules 208, 210, and/or 212, described herein is for illustrative purposes, and is not intended to be limiting, as any of the modules 208, 210, and/or 212 may provide more or less functionality than is described. For example, one or more of the modules 208, 210, and/or 212 may be eliminated, and some or all of its functionality may be provided by other ones of the modules 208, 210, and/or 212.

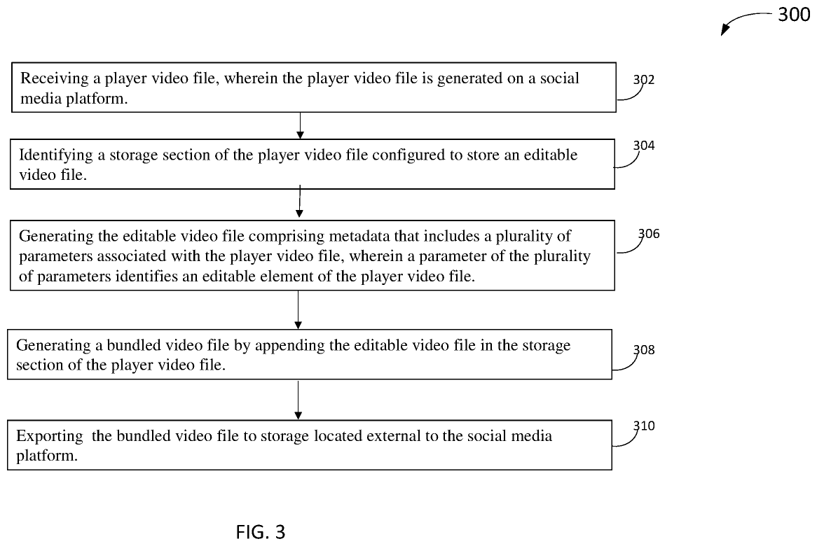

FIG. 3 illustrates an example flow diagram (e.g., process 300) for bundling metadata into video files, according to certain aspects of the disclosure. For explanatory purposes, the example process 300 is described herein with reference to one or more of the figures above. Further for explanatory purposes, the steps of the example process 300 are described herein as occurring in serial, or linearly. However, multiple instances of the example process 300 may occur in parallel. For purposes of explanation of the subject technology, the process 300 will be discussed in reference to one or more of the figures above.

At step 302, the process 300 may include receiving a player video file, wherein the player video file is generated on a social media platform. At step 304, the process may include identifying a storage section of the player video file configured to store an editable video file. At step 306, the process may include generating the editable video file comprising metadata that includes a plurality of parameters associated with the player video file. A parameter of the plurality of parameters identifies an editable element of the player video file. At step 308, the process 300 may include generating a bundled video file by appending the editable video file in the storage section of the player video file. At step 308, the process 300 may include exporting the bundled video file to storage located external to the social media platform.

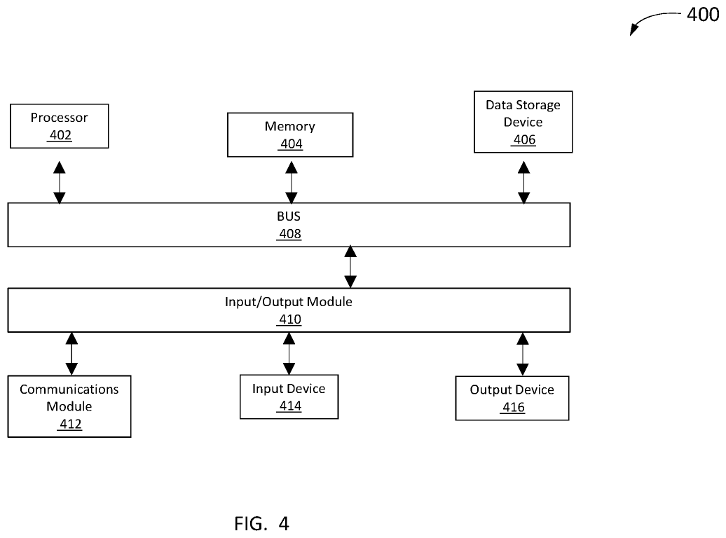

FIG. 4 is a block diagram illustrating an exemplary computer system 400 with which aspects of the subject technology can be implemented. In certain aspects, the computer system 400 may be implemented using hardware or a combination of software and hardware, either in a dedicated server, integrated into another entity, or distributed across multiple entities.

The computer system 400 (e.g., server and/or client) includes a bus 408 or other communication mechanism for communicating information, and a processor 402 coupled with the bus 408 for processing information. By way of example, the computer system 400 may be implemented with one or more processors 402. Each of the one or more processors 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer-readable medium for execution by, or to control the operation of, the computer system 400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by the processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 400 further includes a data storage device 406 such as a magnetic disk or optical disk, coupled to bus 408 for storing information and instructions. The computer system 400 may be coupled via input/output module 410 to various devices. The input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 416 include display devices such as an LCD (liquid crystal display) monitor, for displaying information to the user.

According to one aspect of the present disclosure, the above-described systems can be implemented using a computer system 400 in response to the processor 402 executing one or more sequences of one or more instructions contained in the memory 404. Such instructions may be read into memory 404 from another machine-readable medium, such as data storage device 406. Execution of the sequences of instructions contained in the main memory 404 causes the processor 402 to perform the process steps described herein. One or more processors in a multi-processing arrangement may also be employed to execute the sequences of instructions contained in the memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 400 can include clients and servers. A client and server are generally remote from each other and typically interact through a communication network. The relationship of client and server arises by virtue of computer programs running on the respective computers and having a client-server relationship to each other. The computer system 400 can be, for example, and without limitation, a desktop computer, laptop computer, or tablet computer. The computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 402 for execution. Such a medium may take many forms, including, but not limited to, non-volatile media, volatile media, and transmission media. Non-volatile media include, for example, optical or magnetic disks, such as the data storage device 406. Volatile media include dynamic memory, such as the memory 404. Transmission media include coaxial cables, copper wire, and fiber optics, including the wires that comprise the bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Data from memory 404 servers accessed via a network, the bus 408, or the data storage 406 may be read and loaded into the memory 404. Although data is described as being found in the memory 404, it will be understood that data does not have to be stored in the memory 404 and may be stored in other memory accessible to the processor 402 or distributed among several media, such as the data storage 406.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method for bundling data files, wherein the method comprises:
receiving a player video file, wherein the player video file is generated on a social media platform;
identifying a storage section of the player video file configured to store an editable video file;
generating the editable video file comprising metadata that includes a plurality of parameters associated with the player video file, wherein a parameter of the plurality of parameters identifies an editable element of the player video file;
generating a bundled video file by appending the editable video file in the storage section of the player video file; and
exporting the bundled video file to storage located external to the social media platform.

2. The method of claim 1, wherein each parameter of the plurality of parameters comprises a unique identifier.

3. The method of claim 1, further comprising updating the metadata in response to a change to the player video file.

4. The method of claim 1, wherein bundling the metadata comprises generating the metadata after a predetermined timing threshold has elapsed from initiating of the player video file.

5. The method of claim 1, further comprising restricting a parameter such that a value or configuration associated with the player video file is restricted from alteration.

6. The method of claim 1, further comprising authenticating access to the bundled video file based on an attempt to access the bundled video file.

7. The method of claim 1, further comprising retrieving the bundled video file and determining whether the parameter is valid.

8. The method of claim 7, wherein a notification is provided to a user that access to adjust the player video file is denied, wherein the parameter is not valid.

9. A system configured for bundling a plurality of files, the system comprising one or more hardware processors configured by machine-readable instructions to:
receive a player video file, wherein the player video file is generated on a social media platform;
identify a storage section of the player video file configured to store an editable video file;
generate the editable video file comprising metadata that includes a plurality of parameters associated with the player video file, wherein a parameter of the plurality of parameters identifies an editable element of the player video file;
generate a bundled video file by appending the editable video file in the storage section of the player video file; and
export the bundled video file to storage located external to the social media platform.

10. The system of claim 9, wherein the one or more hardware processors are further configured by machine-readable instructions to update the metadata in response to a change to the player video file.

11. The system of claim 9, wherein bundling the metadata comprises generating the metadata after a predetermined timing threshold has elapsed from initiating the player video file.

12. The system of claim 9, wherein the one or more hardware processors are further configured by machine-readable instructions to restrict a parameter such that a value or configuration associated with the player video file is restricted from alteration.

13. The system of claim 9, wherein the one or more hardware processors are further configured by machine-readable instructions to access the bundled video file based on an attempt to access the bundled video file.

14. The system of claim 9, wherein the one or more hardware processors are further configured by machine-readable instructions to retrieve the bundled video file and determine whether the parameter is valid.

15. The system of claim 14, wherein a notification is provided to a user that access to adjust the bundled video file is denied, wherein the parameter is not valid.

16. A non-transitory computer-readable storage medium comprising instructions stored thereon, which when executed by one or more processors cause the one or more processors to perform a method for bundling data files, comprising:
receiving a player video file, wherein the player video file is generated on a social media platform;
identifying a storage section of the player video file configured to store an editable video file;
generating the editable video file comprising metadata that includes a plurality of parameters associated with the player video file, wherein a parameter of the plurality of parameters identifies an editable element of the player video file;
generating a bundled video file by appending the editable video file in the storage section of the player video file; and
exporting the bundled video file to storage located external to the social media platform.

17. The non-transient computer-readable storage medium of claim 16, wherein the method further comprises updating the metadata in response to a change to the player video file.

18. The non-transient computer-readable storage medium of claim 16, wherein the method further comprises restricting a parameter such that a value or configuration associated with the player video file is restricted from alteration.

19. The non-transient computer-readable storage medium of claim 16, wherein the method further comprises retrieving the bundled video file and determining whether the parameter is valid.

20. The non-transient computer-readable storage medium of claim 16, wherein the method further comprises authenticating access to the bundled video file based on attempting to access the bundled video file.
